(19) United States
(12) Patent Application Publication
(10) Pub. No.: US 2008/0037290 A1
(43) Pub. Date: Feb. 14, 2008

(54) AC-DC CONVERTER AND METHOD FOR DRIVING FOR AC-DC CONVERTER

(75) Inventors: Sadanori Suzuki, Kariya-shi (JP); Kiminori Ozaki, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/837,093

(22) Filed: Aug. 10, 2007

(30) Foreign Application Priority Data
Aug. 11, 2006 (JP) 2006-218544

(51) Int. Cl. H02M 7/219; H02M 7/217

(52) U.S. Cl. 363/17; 363/25

(57) ABSTRACT

A device for converting AC voltage to DC voltage. The device includes an AC input circuit, a rectifier circuit, a first switch, and a second switch. The AC input circuit includes a pair of first input terminals to which AC current is input, a pair of first output terminals, and at least one inductance element arranged in a path extending from the first input terminals to the first output terminals. The rectifier circuit includes a pair of second input terminals, a pair of second output terminals from which DC current is output, a transformer connected to the second input terminals, and a rectifier arranged between the transformer and the second output terminals. The first switch is connected between the first output terminals and the second input terminals. The second switch is connected between the first output terminals.

### CROSS-REFERENCE TO RELATED APPLICATIONS

This application is based upon and claims the benefit of priority from the prior Japanese Patent Application No. 2006-219544, filed on Aug. 11, 2006, the entire contents of which are incorporated herein by reference.

### BACKGROUND OF THE INVENTION

The present invention relates to an AC-DC converter for converting alternating current (AC) voltage to direct current (DC) voltage and a method for driving an AC-DC converter.

FIG. 12 is a circuit block diagram of an AC inverter described in Japanese Laid-Open Patent Publication No. 2002-315351. One end of a power supply line 210a is connected to a power supply terminal of a DC input unit 210, such as a battery (e.g., a DC 12 V battery). The other end of the power supply line 210a is connected to a DC input filter 230, which may be formed by a choke coil and a capacitor. A DC-DC switching circuit 240, which is a push-pull circuit, oscillates DC 12V power from the DC input unit 210 at a frequency of, for example, 55 kHz. The high-frequency oscillation performed by the switching circuit 240 generates a high voltage output (e.g., 140 V) in a high voltage coil of a transformer 250. A DC high-voltage rectifier circuit 260 smoothes the waveform of the high-voltage output. Output voltage of the rectifier circuit 260 is supplied to a drive circuit 280 via a DC output line 260a. The drive circuit 280 (an AC inverter circuit) includes, for example, four FETs (field effect transistors) that are connected in an H-bridge with respect to two AC output lines 280a and 280b. The drive circuit 280 generates an AC voltage of, for example, 55 Hz at the AC output lines 280a and 280b by alternately driving two diagonal FETs at a predetermined duty ratio. The AC voltage is supplied from the AC output lines 280a and 280b to the AC output filter 290. The AC voltage is also supplied from the filter 290 to an AC output unit 300 through the AC output lines 290a and 290b.

The AC inverter described in Japanese Laid-Open Patent Publication No. 2002-315351 converts DC voltage to AC voltage and does not covert AC voltage to DC voltage.

In the device shown in FIG. 12, when the switching circuit 240 and the drive circuit 280 each include an FET, which is an element having an anti-parallel diode, and the DC high-voltage rectifier circuit 260 is formed by a switching element, the switching circuit 240 and the drive circuit 280 may function as a rectifier circuit. This enables AC voltage input from the AC output unit 300 to be output as DC voltage from the DC input unit 210. However, in such a case, the circuit configuration becomes complicated and the number of components increases. Further, this may increase loss resulting from circuit operations, such as switching loss. As a result, the power conversion efficiency may become insufficient. Further, the large number of components may increase the circuit scale and raise the component cost and manufacturing cost.

### SUMMARY OF THE INVENTION

The present invention provides a novel circuit configuration for directly converting input AC voltage to a desired DC voltage.

One aspect of the present invention is a device for converting AC voltage to DC voltage. The device is provided with an AC input circuit including a pair of first input terminals to which AC voltage is input, a pair of first output terminals, and at least one inductance element arranged in a path extending from the first input terminals to the first output terminals. A rectifier circuit includes a pair of second input terminals, a pair of second output terminals from which DC voltage is output, a transformer connected to the second input terminals, and a rectifier arranged between the transformer and the second output terminals. A first switch is connected between the first output terminals and the second input terminals. A second switch is connected between the first output terminals.

Another aspect of the present invention is a device for converting AC voltage to DC voltage. The device includes an AC input circuit to which the AC voltage is input. The AC input circuit includes an inductance element. A rectifier circuit converts voltage having a polarity that is in accordance with a polarity of the AC voltage to DC voltage. The rectifier circuit insulates the voltage having the polarity that is in accordance with the polarity of the AC voltage from the DC voltage with respect to direct current. A first switch is arranged between the rectifier circuit and the AC input circuit to stop current flow between the rectifier circuit and the AC input circuit. A second switch is arranged between the first switch and the AC input circuit to connect or disconnect a pair of output terminals in the AC input circuit.

A further aspect of the present invention is a method for driving a device for converting AC voltage to DC voltage. The device includes an AC input circuit having a pair of first input terminals to which AC voltage is input, a pair of first output terminals, and at least one inductance element arranged in a path extending from the first input terminals to the first output terminals. A rectifier circuit includes a pair of second input terminals, a pair of second output terminals from which DC voltage is output, a transformer connected to the second input terminals, and a rectifier arranged between the transformer and the second output terminals. A first switch is connected between the first output terminals and the second input terminals. A second switch is connected between the first output terminals. The method includes simultaneously activating the first switch and the second switch, and then, alternately activating the first switch and the second switch.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a circuit block diagram of an AC-DC converter according to the present invention;

FIG. 2 is a circuit block diagram illustrating an AC-DC conversion operation in an AC-DC converter according to a preferred embodiment of the present invention;

FIG. 3 is a diagram showing the AC-DC converter of FIG. 2 in operation state (1);

FIG. 4 is a diagram showing the AC-DC converter of FIG. 2 in operation state (2);

FIG. 5 is a diagram showing the AC-DC converter of FIG. 2 in operation state (3);

FIG. 6 is a diagram showing the AC-DC converter of FIG. 2 in operation state (4);

FIG. 7 is a diagram showing the AC-DC converter of FIG. 2 in operation state (5);

FIG. 8 is a circuit block diagram illustrating a DC-AC conversion operation in an AC-DC converter according to a preferred embodiment of the present invention;

FIG. 9 is a schematic circuit block diagram of a first modification of the AC-DC converter;

FIG. 10 is a schematic circuit block diagram of a second modification of the AC-DC converter;

FIG. 11 is a schematic circuit block diagram of a third modification of the AC-DC converter; and

FIG. 12 is a schematic circuit block diagram of a conventional AC inverter.

### DETAILED DESCRIPTION OF THE PREFERRED EMBODIMENTS

In the drawings, like numerals are used for like elements throughout.

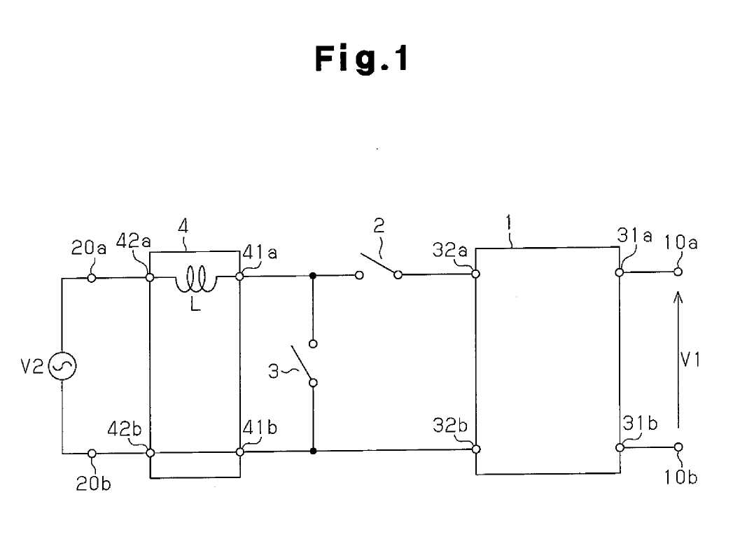

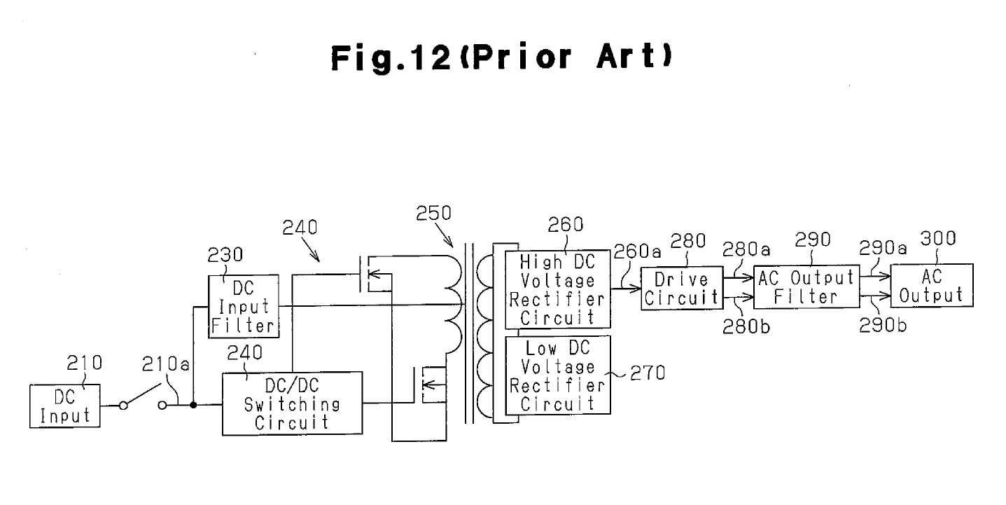

An AC-DC converter according to a preferred embodiment of the present invention will now be described in detail with reference to FIGS. 1 to 12.

FIG. 1 shows the principles of the AC-DC converter in the present invention. In this AC-DC converter, AC voltage V2 is input from AC input terminals 20a and 20b, and DC voltage V1 is output from DC output terminals 10a and 10b. The AC input terminals 20a and 20b are connected to input terminals 42a and 42b, which function as a pair of first input terminals, of an AC input circuit 4. One of output terminals 41a and 41b, which function as a pair of first output terminals, of the AC input circuit 4 is connected to one of input terminals 32a and 32b, which function as a pair of second input terminals, of a rectifier circuit 1 via a first switch 2. The other one of the output terminals 41a and 41b of the AC input circuit 4 is directly connected to the other one of the input terminals 32a and 32b of the rectifier circuit 1. A second switch 3 is connected between the output terminals 41a and 41b of the AC input circuit 4. Output terminals 31a and 31b, which function as a pair of second output terminals, of the rectifier circuit 1 are connected to the DC output terminals 10a and 10b.

In the AC input circuit 4, at least one coil, which functions as an inductance element, is arranged in a path extending from the input terminals 42a, 42b to the output terminals 41a, 41b.

Although not shown in FIG. 1, the rectifier circuit 1 includes a transformer, which is connected to the input terminals 32a and 32b, and a rectifier, which is arranged between the transformer and the output terminals 31a and 31b. The input terminals 32a and 32b are electrically insulated from the output terminals 31a and 31b such that direct current does not flow therebetween. The rectifier circuit 1 converts voltage having a polarity that is in accordance with a polarity of the AC voltage V2 applied to the input terminals 32a and 32b into DC voltage. Then, the rectifier circuit 1 outputs the converted DC voltage V1 from the output terminals 31a and 31b.

The voltage applied to the input terminals 32a and 32b changes polarity in accordance with the polarity of the AC voltage V2 and changes level in accordance with the operation of the first switch 2 and the second switch 3. The operational frequency of the first switch 2 and the second switch 3 is significantly higher than the frequency of the AC voltage V2. The first and second switches 2 and 3 are both activated for a certain period and then alternately activated. That is, after the first switch 2 and the second switch 3 are simultaneously activated, the first and second switches 2, 3 are alternately activated. When the second switch 3 is activated, the output terminals 41a and 41b are short-circuited. This ensures that a path for the flow of current is formed in the AC input circuit 4. In this state, energy is accumulated in the coil L. In a state in which the second switch 3 is deactivated and the first switch 2 is activated, AC voltage V2 is increased by an amount corresponding to the energy accumulated in the coil L, and the increased AC voltage is applied to the input terminals 32a and 32b via the first switch 2. At least either one of the first switch 2 and the second switch 3 is activated. This constantly ensures a path for the current that flows through the coil L. Thus, voltage surge does not occur. When the polarity of the AC voltage V2 is inverted, as the current flowing through the AC input circuit 4 reverses direction, the polarity of the voltage applied to the input terminals 32a and 32b is inverted. However, the voltage applied to the input terminals 32a and 32b is rectified by the rectifier of the rectifier circuit 1. Thus, DC voltage is output from the DC output terminals 10a and 10b regardless of the polarity of the AC voltage V2. The amount of energy accumulated in the coil L is controlled by adjusting the ratio of the period the second switch 3 is activated during a switching control cycle of the first switch 2 and the second switch 3. As described above, the energy accumulated in the coil L is used to increase the voltage of the AC input circuit 4 when the second switch 3 is deactivated and the first switch 2 is activated. Accordingly, the voltage applied to the input terminals 32a and 32b of the rectifier circuit 1 (i.e., the voltage obtained by increasing the AC voltage V2 by an amount corresponding to the energy accumulated in the coil L) is controlled by deactivating the second switch 3 and taking into consideration the AC voltage V2 when the first switch 2 is activated. Thus, the level of the DC voltage V1 output from the DC output terminals 10a and 10b can be controlled. This obtains DC voltage V1 having the desired voltage value regardless of the polarity of the AC voltage V2.

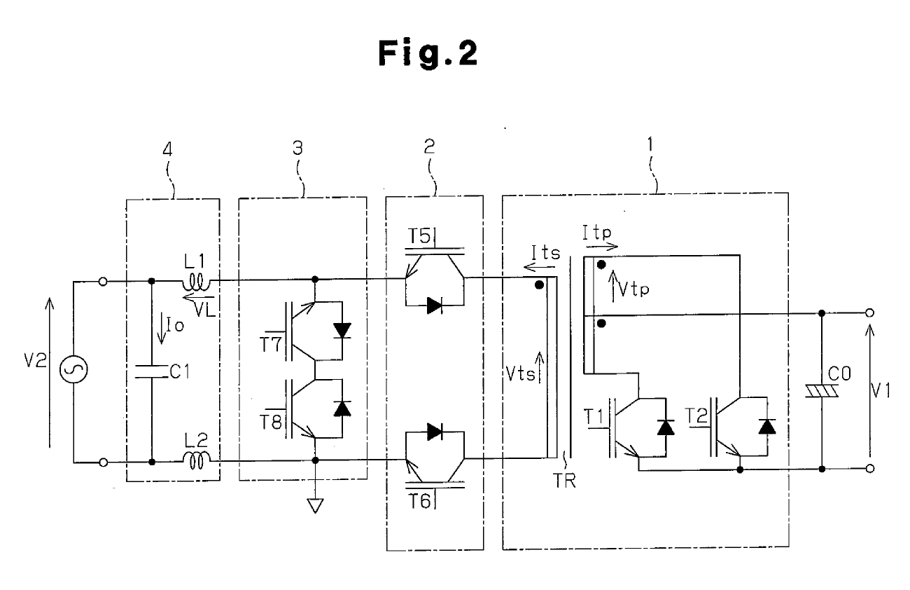

FIG. 2 is a block circuit diagram of the AC-DC converter according to the preferred embodiment of the present invention. The rectifier circuit 1 includes a transformer TR, which includes a primary coil, a secondary coil, and insulated gate bipolar transistor (IGBT) elements T1 and T2. The secondary coil of the transformer TR includes first and second coils and a center tap connecting the first and second coils. The IGBT elements T1 and T2 each include an anti-parallel diode. The IGBT elements T1 and T2 have emitter terminals that are connected to each other. The IGBT element T1 has a collector terminal connected to one terminal of the first coil in the secondary coil. The IGBT element T2 has a collector terminal connected to one terminal of the second coil in the secondary coil. The center tap connects the other terminal of the first coil and the other terminal of the second coil. A smoothing capacitor CO is connected between the emitter terminals of the IGBT elements T1 and T2 and the center tap of the transformer TR. The DC voltage V1 is output to the emitter terminals of the IGBT elements Ti and T2 that function as a negative side. The IGBT elements T1 and T2 form a push-pull circuit serving as a switching circuit. Each of the IGBT elements T1 and T2 is a semiconductor switching element having an anti-parallel diode, which functions as a rectifying element. The anti-parallel diodes, the IGBT elements T1 and T2, and the secondary coil of the transformer TR form the rectifier. Thus, the rectifier is a center tap type rectifier circuit.

An IGBT element T5 has a collector terminal connected to one terminal of the primary coil of the transformer TR. An IGBT element T6 has a collector terminal connected to the other terminal of the primary coil of the transformer TR. The IGBT element T5 has an emitter terminal connected to one terminal of the coil L1 of the AC input circuit 4. The IGBT element T6 has an emitter terminal connected to one terminal of the coil L2 of the AC input circuit 4. The IGBT elements T5 and T6 form the first switch 2. Each of the IGBT elements T5 and T6 is a semiconductor switching element having an anti-parallel diode. The first switch 2 maintains a deactivated state between the output terminals 41a and 41b of the AC input circuit 4 and the input terminals 32a and 32b of the rectifier circuit 1 regardless of the polarity of the voltage at the output terminals 41a and 41b of the AC input circuit 4.

The emitter terminal of the IGBT element T7 is connected to a path connecting the emitter terminal of the IGBT element T5 and one terminal of the coil L1. The emitter terminal of the IGBT element T8 is connected to a path connecting the emitter terminal of the IGBT element T6 and one terminal of the coil L2. The IGBT elements T7 and T8 are connected in series in a state in which their collector terminals are connected to each other. The IGBT elements T7 and T8 form the second switch 3. Each of the IGBT elements T7 and T8 is a semiconductor switching element having an anti-parallel diode. The second switch 3 maintains a deactivated state between the input terminals 32a and 32b of the rectifier circuit 1.

The IGBT elements T5, T6, T7, and T8 correspond to semiconductor switching elements. The first terminals of the coils L1 and L2 correspond to the pair of output terminals 41a and 41b of the AC input circuit 4. The second terminals of the coils L1 and L2 correspond to the pair of input terminals 42a and 42b of the AC input circuit 4. The smoothing capacitor C1 is connected between the second end of the coil L1 and the second end of the coil L2.

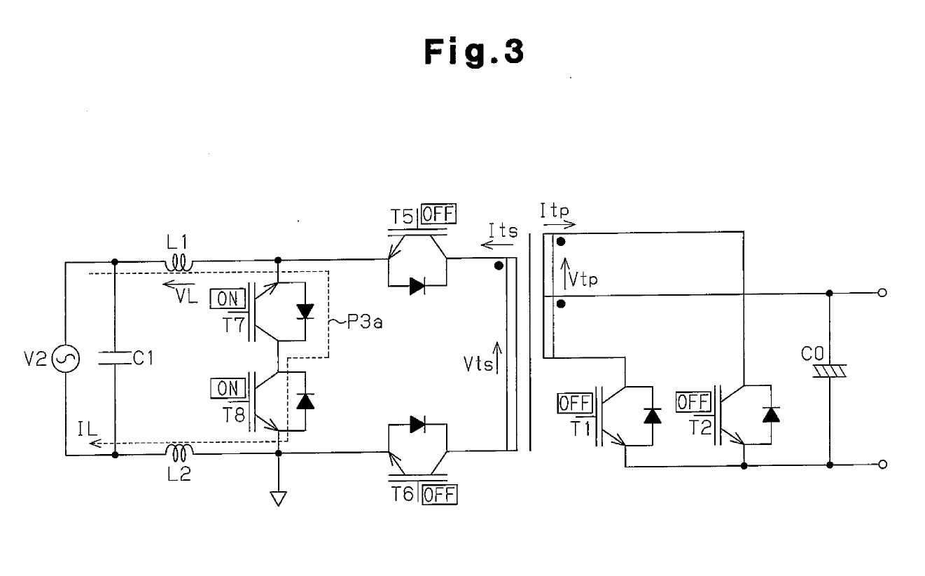

The circuit operation of the AC-DC converter shown in FIG. 2 will now be described with reference to FIGS. 3 to 7. The operation of the switching control performed with the IGBT elements T1, T2, and T5 to T8 during a single switching control cycle is shown stage-by-stage in FIGS. 3 to 7.

In operation state (1) shown in FIG. 3, when the IGBT elements T7 and T8 are activated, coil current IL corresponding to the AC voltage V2 flows through the coils L1 and L2, and electromagnetic energy is accumulated in the coils L1 and L2. The direction of the coil current IL is changed in accordance with the AC voltage V2. FIG. 3 shows that in operation state (1), the potential is higher at the coil L2 than the coil L1. As a result, the coil current IL flows to the coil L2 via the coil L1, the anti-parallel diode of the IGBT element T7, and the IGBT element T8.

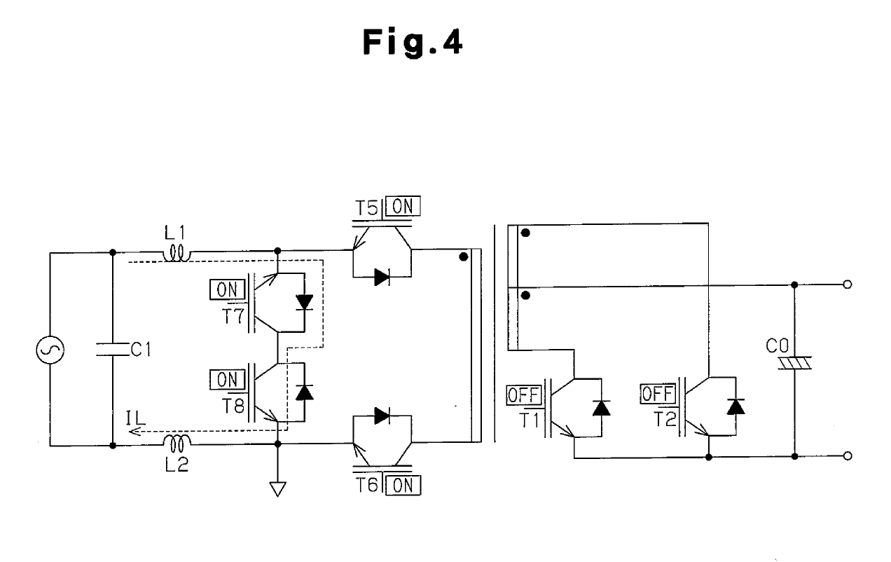

Next, in operation state (2) shown in FIG. 4, while the IGBT elements T7 and T8 remain activated, the IGBT elements T5 and T6 are activated. The coil current IL continues to flow from the operation state (1) shown in FIG. 3.

In this case, the IGBT elements T7 and T8 remain activated. Thus, current does not flow to the IGBT elements T5 and T6.

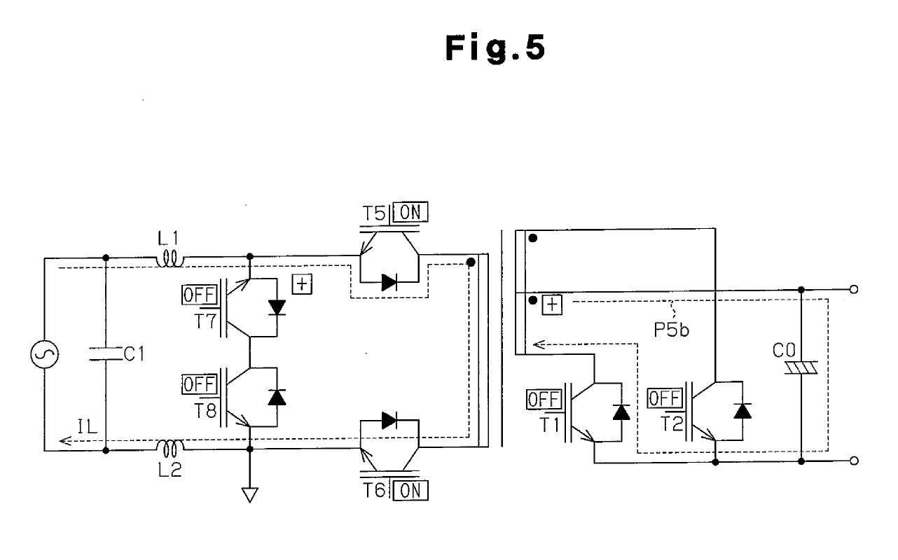

In operation state (3) shown in FIG. 5, the IGBT elements T7 and T8 are deactivated in a state in which the IGBT elements T5 and T6 are activated. Coil current IL which flows from the coils L1 and L2 flows to the coil L2 from the coil L1 via the anti-parallel diode of the IGBT element T5, the primary coil of the transformer TR (left coil of the transformer TR as viewed in FIG. 5) and the IGBT element T6. The IGBT elements T5 and T6 are activated before the IGBT elements T7 and T8 are deactivated. Accordingly, turn-on loss does not occur. The coil current IL excites the transformer TR and generates voltage in the secondary coil of the transformer TR (right coil of the transformer TR as viewed in FIG. 5). The coil current IL flows to a reference terminal (a terminal connected to the collector terminal of the IGBT element T5) of the primary coil of the transformer TR. Thus, in the secondary coil of the transformer TR, voltage is induced in the first coil using the reference terminal of the first coil as a positive potential. As a result, as indicated by arrow P5b, current flows through a path extending from the center tap of the transformer TR to the capacitor CO, the anti-parallel diode of the IGBT element T1, and back to the secondary coil of the transformer TR. In the secondary coil of the transformer TR, voltage is induced in the second coil using the reference terminal of the second coil as a positive potential. However, the direction of the current is such that current flows from the cathode to anode of the anti-parallel diode of the IGBT element T2. Thus, current does not flow through the path of the IGBT element T2.

When the IGBT element T7 is switched from an activated state to a deactivated state, the collector-emitter voltage of the IGBT element T7 does not change. This is because the anti-parallel diode of the IGBT element T7 remains in the activated state. Thus, switching loss does not occur in the IGBT element T7 during switching control of the IGBT element T7.

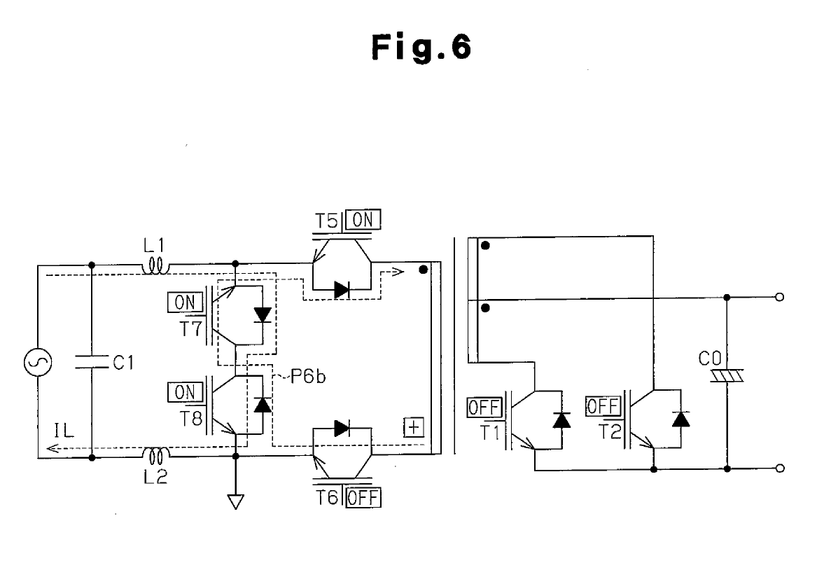

In operation state (4) shown in FIG. 6, the IGBT elements T7 and T8 are activated in a state the IGBT elements T5 and T6 are activated. In the same manner as the operation states (1) and (2) shown in FIGS. 3 and 4, coil current IL corresponding to the AC voltage V2 flows to the coils L1 and L2 via the IGBT elements T7 and T8. This accumulates electromagnetic energy in the coils L1 and L2. In operation state (4) shown in FIG. 6, AC voltage V2 that causes the potential at the coil L1 to be higher than that at the coil L2 is supplied.

At the same time, the excitation current of the transformer TR flows through the primary coil. That is, as shown by the arrow P6b, the excitation current of the transformer TR flows through a path extending from the IGBT element T6, the anti-parallel diode of the IGBT element T8, the IGBT element T7, the anti-parallel diode of the IGBT element T5, and back to the primary coil.

In the operation state (4) shown in FIG. 6, the primary coil of the transformer TR is short-circuited. Thus, excitation current flows through the primary coil but does not flow through the secondary coil. When the IGBT element T7 is switched from a deactivated state to an activated state, the voltage does not change between the collector and emitter of the IGBT element T7. Thus, turn-on loss does not occur during switching control of the IGBT element T7.

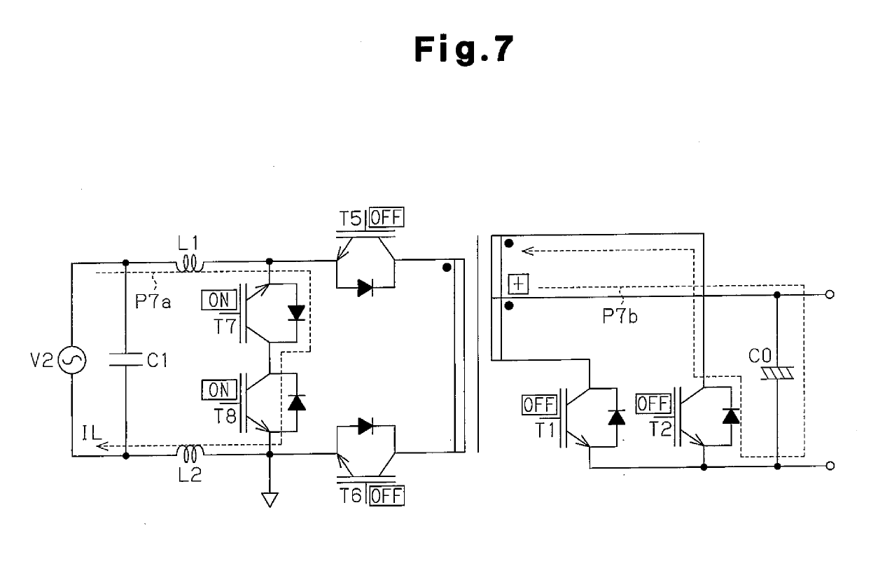

In operation state (5) shown in FIG. 7, the IGBT elements T5 and T6 are deactivated in a state in which the IGBT elements T7 and T8 are activated. As indicated by the arrow P7a, the coil current IL continues to flow from the operation state (4) of FIG. 6.

At the same time, the excitation current of the transformer TR flows to the secondary coil instead of the primary coil. That is, as indicated by arrow P7b, the excitation current of the transformer TR flows through a path extending from the central tap, the capacitor CO, the anti-parallel diode of the IGBT element T2, and back to the secondary coil. The transformer TR is reset when there is not current generated from the excitation energy.

The AC-DC converter returns to the operation state (1) of FIG. 3 when the transformer TR is reset. Subsequently, operation states (1) to (5) shown in FIGS. 3 to 7 are repeated to convert the AC voltage V2 into the DC voltage V1. The frequency during switching control of the IGBT elements T1, T2, T5, T6, T7, and T8 in the operation states (1) to (5) is sufficiently higher than the frequency of the AC voltage V2. As for the polarity of the AC voltage V2, a case in which the potential at the coil L1 is higher than that at the coil L2 has been discussed above. When the polarity of the AC voltage V2 is inverted, the direction of the excitation current flowing through the primary coil of the transformer TR is reversed. Accordingly, in the operation state of FIG. 5, in the secondary coil of the transformer TR, current flows through a path extending from the center tap of the transformer TR to the capacitor C0, the anti-parallel diode of the IGBT element T2, and back to the secondary coil of the transformer TR. As a result, voltage that is positive relative to the center tap is generated at the terminal of the secondary coil of the transformer TR that is connected to the IGBT element T1. However, this causes current to flow in the direction from the cathode to the anode of the anti-parallel diode of the IGBT element T1. Thus, current does not flow through the path of the IGBT element Ti. Accordingly, conversion to DC voltage is performed regardless of the polarity of the AC voltage V2.

The level of the DC voltage V1 is controlled in accordance with the level of the AC voltage V2 by adjusting the ratio of the period during which the first switch 2 is activated (operation state of FIG. 3) and the period during which the second switch 3 is activated (operation state of FIG. 5). The percentage of the period during which the IGBT elements T7 and T8 are each activated in a switching control cycle of the IGBT elements T5 to T8 for a period that is controlled to have a negative correlation with the voltage peak value of the AC voltage V2. That is, the percentage of the period during which the IGBT elements T7 and T8 are activated is decreased as the voltage peak value of the AC voltage V2 increases, and the percentage of the period during which the IGBT elements T7 and T8 is increased as the voltage peak value of the AC voltage V2 decreases. When the IGBT elements T7 and T8 are activated, electromagnetic energy is accumulated in the coils L1 and L2. In a state in which the IGBT elements T7 and T8 are deactivated and the IGBT elements T5 and T6 are activated, AC voltage V2 is increased by an amount corresponding to the electromagnetic energy accumulated in the coils L1 and L2 is applied to the primary coil of the transformer TR. Accordingly, the AC voltage V2 is greatly increased as the voltage peak value of the AC voltage V2 becomes smaller and greatly decreased as the voltage peak value of the AC voltage V2 becomes greater. This controls the voltage applied to the transformer TR. Thus, for AC voltage V2 of which the voltage peak value changes as time elapses, the DC voltage V1 is maintained at a generally constant voltage value.

The AC-DC converter of the preferred embodiment maintains the continuity of the excitation current flowing through the coils L1 and L2 and the transformer TR during the state transition period from operation state (2) of FIG. 4 to operation state (4) of FIG. 6. It is preferred that the periods of operation states (1) and (3) be as short as possible.

The IGBT elements T7 and T8 controlled to accumulate electromagnetic energy in the coils L1 and L2 and the IGBT elements T5 and T6 controlled to transmit the electromagnetic energy accumulating in the coils L1 and L2 to the secondary coil of the transformer TR are alternately activated and deactivated so that their activation periods are overlapped. As a result, the energy input as the AC voltage V2 is output as the DC voltage V1. Further, the path of the coil current IL is constantly formed. Thus, the accumulation energy does not generate surge voltage.

The coil current IL follows the voltage peak value of the AC voltage V2 by controlling the period during which the IGBT elements T7 and T8 are activated to have a negative correlation relative to the voltage peak value of the AC voltage V2. This enables the input AC voltage V2 and the coil current IL to have the same phase, and realizes a satisfactory phase factor.

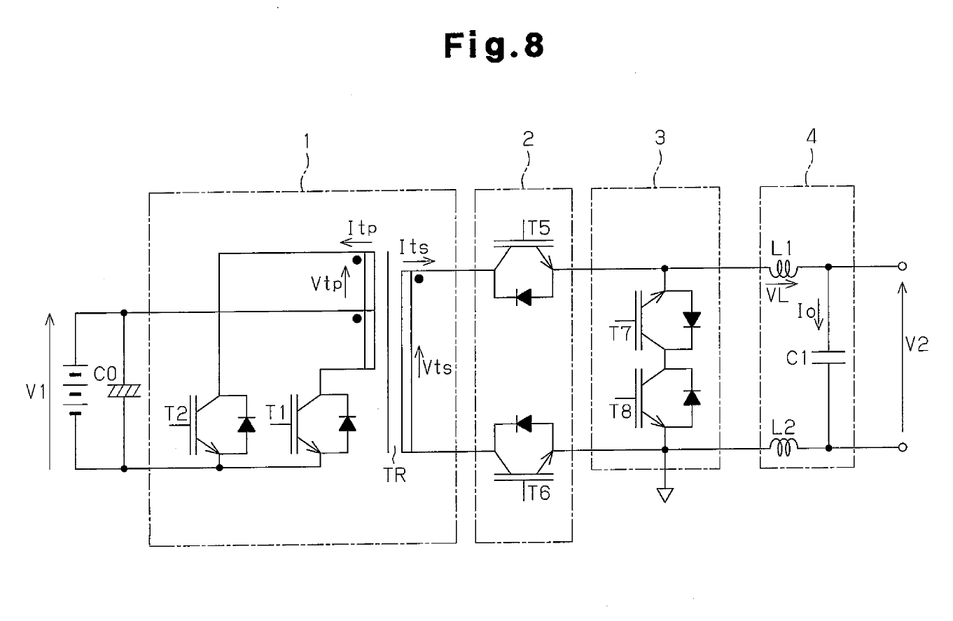

FIG. 8 is a circuit block diagram of the AC-DC converter shown in FIG. 2 when operated as a DC-AC converter. When using the AC-DC converter as a DC-AC converter, DC voltage V1 is input to the DC output terminals 10a and 10b, and AC voltage V2 is output from the AC input terminals 20a and 20b. As shown in FIG. 8, diodes forming the rectifier circuit 1 are diodes that are connected in anti-parallel to the IGBT elements T1 and T2. This enables operation as a DC-AC converter. Hereafter, each component in each circuit block is referred to by the same title as that used when describing the AC-DC converter shown in FIG. 2.

In the example of FIG. 8, in the transformer TR, the primary coil of FIG. 2 functions as the secondary coil, and the secondary coil of FIG. 2 functions as the primary coil. Accordingly, the primary coil includes a first coil, a second coil, and a center tap connecting the coils. DC voltage V1 is input in a state in which the emitter terminals of the IGBT elements T1 and T2 function as a negative pole, and the center tap of the primary coil of the transformer TR functions as a positive pole.

The operation of the DC-AC converter will now be described.

In operation state (6), the IGBT elements T5 and T6, which form the first switch, are activated.

In operation state (7) shown in FIG. 8, the IGBT element Ti (or the IGBT element T2) is activated in a state in which the IGBT elements T5 and T6 are activated. DC voltage V1 is applied to the first coil of the primary coil via the center tap of the transformer TR. Power corresponding to the DC voltage V1 is transferred via the IGBT elements T5 and T6 and the coils L1 and L2 and then output from the output terminals of the AC input circuit 4. This accumulates energy in the coils L1 and L2. When the IGBT element T1 (or the IGBT element T2) is switched from a deactivated state to an activated state, the IGBT elements T5 and T6 are activated. Thus, switching loss of the IGBT element T1 (or the IGBT element T2) does not occur.

In operation state (8), the IGBT element Ti is deactivated in a state in which the IGBT elements T5 and T6 are activated. As a result, due to the continuity of the excitation current of the transformer TR, current flows through a path extending from the center tap of the transformer TR to the power supply of the DC voltage V1, the anti-parallel diode of the IGBT element T2 (or the anti-parallel diode of the IGBT element T1), which is a rectifying diode, and back to the transformer TR. Further, due to the continuity of the current flowing through the coils L1 and L2, current continues to flow through a path including the coils L1 and L2, the IGBT elements T5 and T6, and the secondary coil of the transformer TR.

In operation state (9), the IGBT elements T7 and T8, which form the second switch, is activated in a state in which the IGBT elements T5 and T6 are activated. Excitation current does not flow through the primary coil of the transformer TR. This is because the activation of the IGBT elements T7 and T8 short-circuits the secondary coil of the transformer TR. The current flowing through the coils L1 and L2 flows through the IGBT elements T7 and T8 instead of the IGBT elements T5 and T6.

In operation state (10), the IGBT elements T5 and T6 are deactivated in a state in which the IGBT elements T7 and T8 are activated. Since a current path cannot be formed in the secondary coil of the transformer TR, excitation coil flows through the primary coil. The current flowing through the coils L1 and L2 continuously flows through the IGBT elements T7 and T8. During the period from between operation state (9) to operation state (10), the transformer TR is reset without being excited.

In operation state (11), the IGBT elements T5 and T6 are activated in a state in which the IGBT elements T7 and T8 are activated. There is no excitation current, and only the current flowing through the coils L1 and L2 continue to flow through the IGBT elements T7 and T8.

In operation state (12), the IGBT elements T7 and T8 are deactivated in a state in which the IGBT elements T5 and T6 are activated. The current that flows through the coils L1 and L2 flows through the secondary coil of the IGBT elements T5 and T6 and the secondary coil of the transformer TR. This generates voltage at the primary coil of the transformer TR, and current flows through a path formed by the center tap, the DC voltage V1, and the anti-parallel diode of the IGBT element T2 (or the anti-parallel diode of the IGBT element T1).

The above operation state (6) to operation state (12) are repeated as a single cycle. The level of the voltage output from the terminals of the AC input circuit 4 are controlled by adjusting the ratio of the period of the operation state (7) and the period of the operation state (10). More specifically, the AC voltage V2 increases as the time for operation state (7) becomes longer than the time for operation state (10), and the AC voltage V2 decreases as the time for operation state (7) becomes shorter than the time for operation state (10). Operation states (8), (9), (11), (12), and (1) maintain the continuity of the current flowing through the coils in the circuit. It is preferred that the periods of operation states (8), (9), (11), (12), and (1) be as short as possible.

In operation state (7), the IGBT element T2 may be activated to transfer power to the secondary coil of the transformer TR. The polarity of the voltage generated in the secondary coil of the transistor TR is inverted by activating the IGBT element T2 in lieu of the IGBT element T1. This outputs AC voltage, which has an inverted polarity, from the terminals of the AC input circuit 4. That is, the cycle during which the IGBT element T1 is activated and the cycle during which the IGBT element T2 is activated may be switched and the polarity of the voltage generated at the terminals of the AC input circuit 4 may be controlled to generate AC voltage. This ensures that a path for the current that flows through the coils L1 and L2 is constantly provided.

For example, the cycle during which the IGBT element T1 is activated and the cycle during which the IGBT element T2 is activated may be switched in accordance with the frequency of the desired AC voltage, and each IGBT element may be operated by repeating each cycle at a frequency that is sufficiently higher than the desired AC voltage. This generates alternating current having a desirable voltage waveform at the terminals of the AC input circuit 4.

In the above operation states, either the IGBT elements T5 and T6, which form the first switch, or the IGBT elements T7 and T8, which form the second switch, are activated. This constantly generates current at the coils L1 and L2. Thus, surge voltage is not generated.

During the period between operation state (10) and operation state (11), the resetting of the transformer TR may be ensured by adding a step for activating the IGBT element T2 (or T1) and applying voltage having a polarity that is inversed from the voltage applied to the primary coil of the transformer TR in operation state (7).

In the preferred embodiment, the AC voltage input to the AC input terminals 20a and 20b is input to the AC input circuit 4 via the pair of first input terminals 42a and 42b by activation of the second switch 3, and electromagnetic energy having a polarity that is in accordance with the polarity of the AC voltage V2 is accumulated in the AC input circuit 4. Afterwards, activation of the first switch 2 and deactivation of the second switch 3 supplies voltage that has been increased by an amount corresponding to the electromagnetic energy accumulated in the AC input circuit 4 to the rectifier circuit 1 via the pair of input terminals 32a and 32b from the pair of output terminals 41a and 41b. Then, DC voltage V1 is output from the pair of output terminals 31a and 31b. In the rectifier circuit 1, the input terminals 32a and 32b are insulated from the output terminals 31a and 31b such that direct current does not flow therebetween. DC voltage that is not related with the polarity of the AC voltage applied to the input terminals 32a and 32b is output from the output terminals 31a and 31b of the rectifier circuit 1. Accordingly, when the AC voltage V2 that is input and the DC voltage V1 that is output are insulated from each other with respect to direct current, after a period during which the first switch 2 and the second switch 3 are both activated, the first switch 2 and the second switch 3 are alternately activated to directly convert the input AC voltage V2 into the desired DC voltage.

The IGBT element T5 and the IGBT element T6, each having an anti-parallel diode, are connected in reverse directions with respect to the current path to form the first switch 2. Thus, regardless of the voltage polarity, control of bidirectional conduction and non-conduction are enabled. In the same manner, the IGBT element T7 and the IGBT element T8, each having an anti-parallel diode, are connected in reverse directions with respect to the current path to form the second switch 2. Thus, regardless of the voltage polarity, control of bidirectional conduction and non-conduction are enabled.

The AC-DC converter of FIG. 2 includes the IGBT elements T5 and T7 having emitter terminals that are connected to each other and the IGBT elements T6 and T8 having emitter terminals that are connected to each other. As a result, during switching control, the reference potentials at the IGBT elements T5 and T7 may be equalized. Thus, a common drive power supply may be used. Accordingly, the switching control of the IGBT elements T5 and T7 and the IGBT elements T6 and T8 and the drive power supply may be simplified.

The AC-DC converter of the preferred embodiment may be driven so that DC voltage V1 is input to the DC output terminals 10a and 10b and AC voltage V2 is output from the AC input terminals 20a and 20b. In this case, the voltage applied to the output terminals 41a and 41b is smoothed by the AC input circuit 4, and the smoothed voltage is output from the input terminals 42a and 42b. The level and waveform of the AC voltage at the input terminals 42a and 42b are controlled by adjusting the ratio of the period during which the IGBT elements T5 and T6 forming the first switch 2 are activated and the period during which the IGBT elements T7 and T8 forming the second switch 3 are activated. By changing the polarity of the voltage output to the input terminals 32a and 32b, the polarity of the AC voltage V2 of the input terminals 42a and 42b may be controlled. The input DC voltage V1 and the output AC voltage V2 may be insulated so that direct current does not flow, and the DC voltage V1 may be directly converted to the desired AC voltage V2.

The current generated from the excitation energy of the transformer TR flows from the center tap of the secondary coil to the power supply of the DC voltage V1, the anti-parallel diode of the IGBT element T2, and the secondary coil. Thus, the excitation energy of the transformer TR is regenerated to the power supply of the DC voltage V1. The transformer TR is reset when the regeneration is completed and there is no excitation energy of the transformer TR.

It should be apparent to those skilled in the art that the present invention may be embodied in many other specific forms without departing from the spirit or scope of the invention. Particularly, it should be understood that the present invention may be embodied in the following forms.

The rectifier circuit 1 is not limited to the center tap type rectifier circuit formed by the transformer TR including the center tap in the secondary coil and the anti-parallel diodes of the IGBT elements T1 and T2. AC-DC converters according to other embodiments of the present invention will now be described.

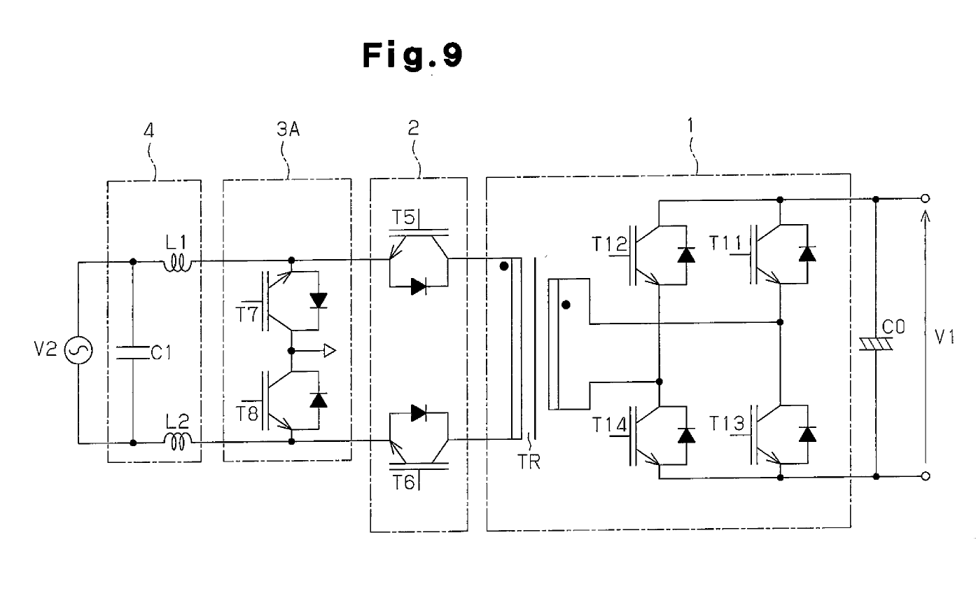

FIG. 9 is a circuit block diagram of an AC-DC converter according to a first modification of the present invention. A rectifier circuit 1A includes a full-bridge rectifier circuit formed by the anti-parallel diode of the IGBT elements T11 to T14.

A secondary coil of the transformer TR has a terminal connected to a connecting point between an emitter terminal of the IGBT element T11 and a collector terminal of the IGBT element T13. The secondary coil of the transformer TR has another terminal connected to a connecting point between an emitter terminal of the IGBT element T12 and a collector terminal of the IGBT element T14. Collector terminals of the IGBT elements T11 and T12 are connected to each other and to a positive pole of a power supply of a DC voltage V1. Emitter terminals of the IGBT elements T13 and T14 are connected to each other and to a negative pole of the power supply of the DC voltage V1. The IGBT elements T11, T12, T13, and T14 are each connected to an anti-parallel diode. The anti-parallel diodes form the full-bridge rectifier circuit. The polarity of the voltage applied to the secondary coil of the transformer TR is inverted by alternately activating the IGBT elements T11 and T14 and the IGBT elements T12 and T13.

The emitter terminals of the IGBT elements T7 and T8 are connected to each other in the first modification of the AC-DC converter shown in FIG. 9. As a result, during switching control, the reference potential at the IGBT elements T7 and T8 may be equalized. Thus, a common drive power supply may be used. Accordingly, the switching control of the IGBT elements T7 and T8 and the drive power supply may be simplified.

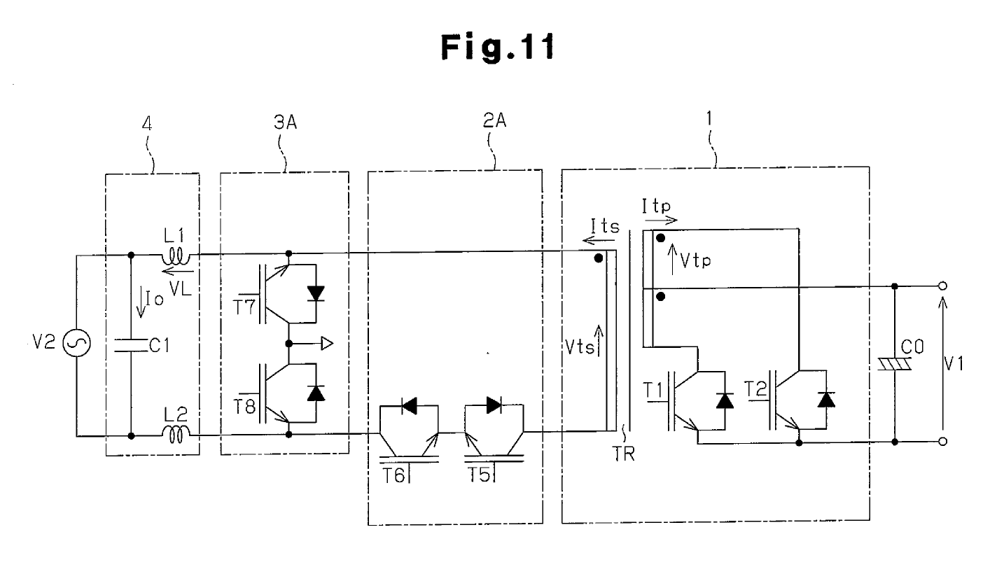

In the same manner, in a fourth modification of the AC-DC converter shown in FIG. 11, the emitter terminals of the IGBT elements T5 and T6 may be connected to each other. As a result, during switching control, the reference potential at the IGBT elements T7 and T8 may be equalized. Thus, a common drive power supply may be used. Accordingly, the switching control of the IGBT elements T5 and T6 and the drive power supply may be simplified.

Instead of the IGBT elements T1, T2, T11, T12, T13, and T14, a rectifying element such as a diode arranged in the same direction as the anti-parallel diodes of these IGBT elements may be connected between the secondary coil of the transformer TR and the output terminals 31a and 31b. Instead of a diode or an anti-parallel diode, the rectifier circuit 1 may use a semiconductor switching element to perform a synchronous rectifying operation. In this case, loss caused by the recovery characteristics of a diode can be suppressed.

In the present invention, the collector terminals of the IGBT elements T7 and T8 do not have to be connected to each other. Further, the emitter terminals of the IGBT elements T5 and T7 do not have to be connected to each other. In addition, the emitter terminals of the IGBT elements T6 and T8 do not have to be connected to each other.

The AC-DC converter of the first modification shown in FIG. 9 includes a rectifier circuit 1A in lieu of the rectifier circuit 1 of FIG. 2. The rectifier circuit 1A includes IGBT elements T11, T12, T13, and T14. Further, the AC-DC converter of the first modification includes a second switch 3A instead of the second switch 3. In the second switch 3A, emitter terminals of IGBT elements T7 and T8 are connected to each other. Thus, the activation and deactivation of the second switch 3A are bi-directionally controllable regardless of the polarity of the voltage. Additionally, since the anti-parallel diodes face each other, a path extending through the IGBT elements T7 and T8 is deactivated. Further, IGBT elements T5 and T6 of a first switch 2 and the IGBT elements T7 and T8 of the second switch 3A form a full-bridge circuit. This structure is preferable since a versatile full-bridge driver may be used for switching control of the IGBT elements T5, T6, T7, and T8. This structure is further preferable when the emitter terminals of the IGBT elements T7 and T8 are set at a ground potential.

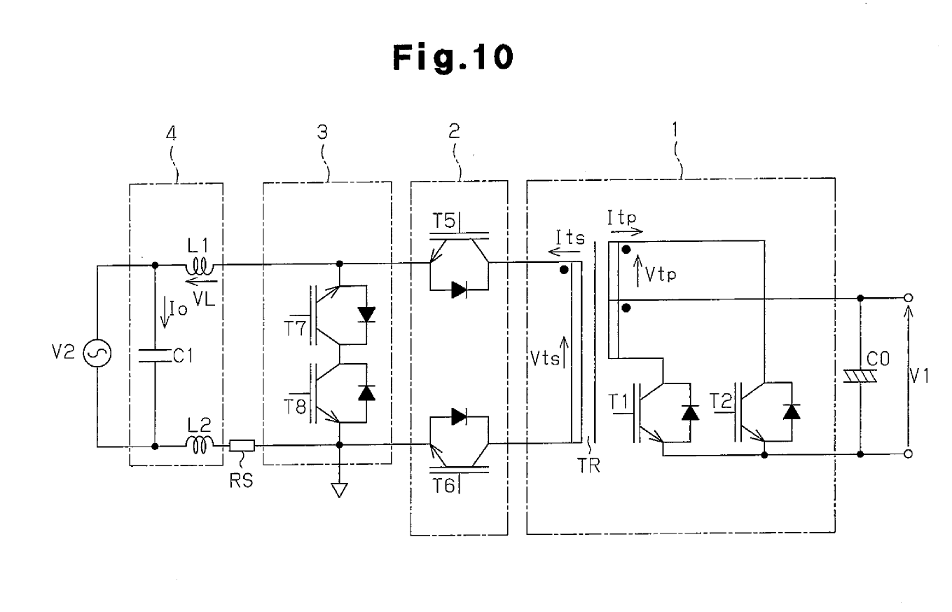

A second modification of an AC-DC converter shown in FIG. 10, the potential at a connecting point for connecting the emitter terminals of the IGBT elements T6 and T8 is a ground potential. Further, the AC-DC converter includes a sense resistor RS between the connecting point and the coil L2. This enables constant detection of the coil current.

During switching control, the potential at a connecting node of the first switch 2 (i.e., the IGBT elements T5 and T6) and the second switch 3 (i.e., the IGBT elements T7 and T8) is a reference potential and is the ground potential. Thus, a large potential fluctuation does not occur during a state of operation. Accordingly, fine voltage may be easily detected from the current flowing through the current sense resistor RS.

FIG. 11 is a circuit block diagram of an AC-DC converter according to a third modification of the present invention. The AC-DC converter includes first and second switches 2A and 3A instead of the first and second switches 2 and 3 included in the AC-DC converter shown in FIG. 2. IGBT elements T5 and T6 are connected in series in a state in which their emitter terminals are connected to each other. The IGBT elements T5 and T6 are arranged between one terminal of a primary coil of a transformer TR and a coil L2. The other terminal of the primary coil of the transformer TR and a coil L1 are directly connected to each other. Accordingly, the emitter terminals of the IGBT elements T5 and T6 are connected to each other. This enables the same reference potential to be used for switching control. As a result, the switching control and the drive power supply are simplified.

In the same manner, the second switch 3A includes IGBT elements T7 and T8 of which emitter terminals are connected to each other. In the same manner, the same drive power supply may be used during switching control for the IGBT elements T7 and T8. This enables the use of a common drive power supply for switching control. Accordingly, the switching control and the drive power supply are simplified.

Further, the emitter terminals of the IGBT elements T7 and T8 are connected to ground. Thus, the drive power supply may be formed using the ground potential as its reference potential.

The rectifier of the rectifier circuits 1 and 1A may be a center tap type rectifier circuit or a full-bridge type rectifier circuit formed only by diodes.

The present examples and embodiments are to be considered as illustrative and not restrictive, and the invention is not to be limited to the details given herein, but may be modified within the scope and equivalence of the appended claims.

What is claimed is:

1. A device for converting AC voltage to DC voltage, the device comprising:
an AC input circuit including a pair of first input terminals to which AC voltage is input, a pair of first output terminals, and at least one inductance element arranged in a path extending from the first input terminals to the first output terminals;
a rectifier circuit including a pair of second input terminals, a pair of second output terminals from which DC voltage is output, a transformer connected to the second input terminals, and a rectifier arranged between the transformer and the second output terminals;
a first switch connected between the first output terminals and the second input terminals; and
a second switch connected between the first output terminals.

2. The device according to claim 1, wherein:
the first switch includes a first semiconductor switching element and a second semiconductor switching element, each including an anti-parallel diode and an emitter terminal or a source terminal;
the first semiconductor switching element is arranged between one of the first output terminals and one of the second input terminals, with the emitter terminal or source terminal of the first semiconductor switching element being connected to the one of the first output terminals; and
the second semiconductor switching element is arranged between another one of the first output terminals and another one of the second input terminals, with the emitter terminal or source terminal of the second semiconductor switching element being connected to the another one of the first output terminals.

3. The device according to claim 2, wherein:
the second switch includes a third semiconductor switching element and a fourth semiconductor switching element, each including an anti-parallel diode and a collector terminal or a drain terminal; and
the third and fourth switching elements are connected in series in a state in which their collector terminals or drain terminals are connected to each other.

4. The device according to claim 2, wherein:
the second switch includes a third semiconductor switching element and a fourth semiconductor switching element, each including an anti-parallel diode and an emitter terminal or a drain terminal; and
the third and fourth switching elements are connected in series in a state in which their emitter terminals or drain terminals are connected to each other.

5. The device according to claim 4, wherein the emitter terminals or source terminals of the third and fourth semiconductor switching elements are connected to a ground potential.

6. The device according to claim 3, wherein the third and fourth switching elements each include an emitter terminal or a source terminal, with the emitter terminal or source terminal of the first semiconductor switching element being connected to the emitter terminal or source terminal of the third semiconductor switching element, and the emitter terminal or source terminal of the second semiconductor switching element being connected to the emitter terminal or source terminal of the fourth semiconductor switching element, the device further comprising:
a current sense resistor arranged between the emitter terminal or source terminal of the fourth semiconductor switching element and one of the first output terminals.

7. The device according to claim 1, wherein:
the first switch includes a first semiconductor switching element and a second semiconductor switching element, each including an anti-parallel diode and an emitter terminal or a source terminal;
the first switch is arranged between one of the first output terminals and one of the second input terminals, with the first and second semiconductor switching elements being connected in series in a state in which the emitter terminals are connected to each other or the source terminals are connected to each other;
another one of the first output terminals and another one of the second input terminals are directly connected to each other; and
the second switch includes a third semiconductor switching element and a fourth semiconductor switching element, each including an anti-parallel diode and an emitter terminal or a source terminal, with the third and fourth semiconductor switching elements being connected in series in a state in which the emitter terminals are connected to each other or the source terminals are connected to each other.

8. The device according to claim 7, wherein the emitter terminals or source terminals of the third and fourth semiconductor switching elements are connected to a ground potential.

9. The device according to claim 1, wherein the rectifier includes a semiconductor switching element having an anti-parallel diode, with the anti-parallel diode forming part of a center tap type rectifier circuit or a full-bridge type rectifier circuit.

10. A device for converting AC voltage to DC voltage, the device comprising:
an AC input circuit to which the AC voltage is input, the AC input circuit including an inductance element;
a rectifier circuit for converting voltage having a polarity that is in accordance with a polarity of the AC voltage to DC voltage, the rectifier circuit insulating the voltage having the polarity that is in accordance with the polarity of the AC voltage from the DC voltage with respect to direct current;
a first switch arranged between the rectifier circuit and the AC input circuit to stop current flow between the rectifier circuit and the AC input circuit; and
a second switch arranged between the first switch and the AC input circuit to connect or disconnect a pair of output terminals in the AC input circuit.

11. A method for driving a device for converting AC voltage to DC voltage, wherein the device includes an AC input circuit having a pair of first input terminals to which AC voltage is input, a pair of first output terminals, and at least one inductance element arranged in a path extending from the first input terminals to the first output terminals, a rectifier circuit including a pair of second input terminals, a pair of second output terminals from which DC voltage is output, a transformer connected to the second input terminals, and a rectifier arranged between the transformer and the second output terminals, a first switch connected between the first output terminals and the second input terminals, and a second switch connected between the first output terminals, the method comprising:
simultaneously activating the first switch and the second switch; and
then, alternately activating the first switch and the second switch.

12. The method according to claim 11, wherein the second switch is activated in a switching control cycle of the first and second switches for a period that is controlled to have a negative correlation with a voltage peak value of the AC voltage.

13. The method according to claim 12, wherein the switching control cycle includes the steps of activating the first switch when the second switch is activated, deactivating the second switch when the first switch is activated, activating the second switch when the first switch is activated, and deactivating the first switch when the second switch is activated, the method further comprising:
repeating said steps of the switching control cycle.
